(19) United States
(12) Patent Application Publication
(10) Pub. No.: US 2001/0023059 A1
(43) Pub. Date: Sep. 20, 2001

(54) Business system for correspondence course and correspondence course system

(76) Inventor: Nozomi Toki, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 09/809,013

(22) Filed: Mar. 16, 2001

(30) Foreign Application Priority Data
Mar. 17, 2000 (JP) 2000-077005

(51) Int. Cl. G09B 5/00; G09B 19/06

(52) U.S. Cl. 434/157; 434/308

(57) ABSTRACT

An educational system server connected to a network comprises a student database for storing student ID, proficiency level, status of payment of tuition and the like of students. The educational system server checks the ability level of the student based on data of the student stored in the student database and, based on the results, selects a course suitable for the student. Further, a next course step suitable for the student is selected according to the current proficiency level of the student. Finally, whether or not the course is to be completed is judged based on the results of grading. By virtue of this constitution, an educational system can be realized wherein a student can select a course, which matches the current proficiency level of the student, and, during taking of the course, can change the course level and can cancel the course.

### FIELD OF THE INVENTION

The invention relates to an education system, and more particularly to a correspondence course system wherein correspondence for education is performed between students and an educational correspondence company through a network such as internet.

### BACKGROUND OF THE INVENTION

In conventional correspondence course, an applicant for correspondence course selects a course based on various guide materials issued by correspondence course entrepreneurs, pays tuition for the selected course, and then receives texts from the entrepreneur by mail. The student performs learning based on the texts. In order to confirm the learning effect, a common practice was such that the student answers questions in a paper contained in the texts and, therefore, correction and guidance are performed by mail. Japanese Patent Laid-Open No. 225547/1995 (System and Method for Educational Course by Correspondence) proposes a system wherein answering of students to questions and correction and guidance by trainers are carried out, for example, by electronic mails (e-mails) through a network such as a telephone line and information, for example, on the status of answering of the student and the scores is accumulated in database through a computer.

The prior art technique, however, suffers from the following problems.

The first problem is that the student per se should select a beginner's level or an intermediate level in the course. This makes it difficult to select the level of a course suitable for the current ability level of the student. The reason for this is that, after the application for correspondence course, the student receives texts and, thus, the student cannot confirm the level of the selected course until the receipt of the texts and the correction and guidance by the trainer.

The second problem is that the student cannot change or cancel the level of the selected course during taking of the course. This is attributable to the fact that, after the application for the correspondence course, the texts are sent at a time and, thus, even when the course has been changed to another course during taking of the course, it is difficult to change or return of the texts.

The third problem is that, for example, in language education, speaking ability and pronunciation cannot be confirmed. This is because correction and guidance by mail or e-mail make it difficult to perform speaking practice and the confirmation of pronunciation.

### SUMMARY OF THE INVENTION

Accordingly, it is an object of the invention to solve the above problems of the prior art and to provide an educational system wherein a student can select a course, which matches the current ability level of the student, and, during taking of the course, can change the course level and can cancel the course.

According to the first feature of the invention, a business system for a correspondence course, comprises an educational system server which educates a student through a communication network, wherein

said educational system server preliminary examines the ability level of the student, and, based on the results of the examination, selects a suitable course for the student.

According to the second feature of the invention, a correspondence course system comprises a terminal on a student side connected through a communication network to an educational system server which transfers examination questions and the results of grading to the terminal on the student side, wherein

said educational system server preliminary examines the ability level of the student, and, based on the results of the examination, selects a suitable course for the student.

According to the systems of the invention, the educational system server is connected to a network and may comprise database means for storing student ID, proficiency level, status of payment of tuition and the like of students. The educational system server may check the proficiency level of the student based on data of the student stored in the student database and, based on the results, selects a course suitable for the student. Further, a next course step suitable for the student may be selected according to the current proficiency level of the student. Finally, whether or not the course is to be completed may be judged based on the results of grading. According to this constitution, the student can select a course, which matches the current proficiency level of the student, and, in addition, during taking of the course, can change the course level and can cancel the course.

Further, according to the systems of the invention, means may be provided which, over a network, can transmit text data, voice data, and image data from the educational system to the student and can receive these types of data from the student. More specifically, the terminal on the student side may be provided with a speaker, a microphone, a display, a camera, and an image scanner, while the educational system server may be provided with speech recognition means for recognizing voice data sent from the student, and image recognition means for recognizing image data sent from the student. This constitution permits the student to confirm his or her own speaking ability and pronunciation, for example, in language education.

### BRIEF DESCRIPTION OF THE DRAWINGS

The invention will be explained in more detail in conjunction with the appended drawings, wherein:

FIG. 1 is a diagram showing the construction of the first preferred embodiment of the invention;

FIG. 2 is a flow diagram showing the operation of the first preferred embodiment of the invention;

FIG. 3 is a flow diagram showing a specific example of the operation of the first preferred embodiment of the invention;

FIG. 4 is a flow diagram showing a specific example of the operation of the first preferred embodiment of the invention; and

FIG. 5 is a flow diagram showing the operation of the second preferred embodiment of the invention.

### DESCRIPTION OF THE PREFERRED EMBODIMENTS

Preferred embodiments of the invention will be explained in detail in conjunction with the accompanying drawings.

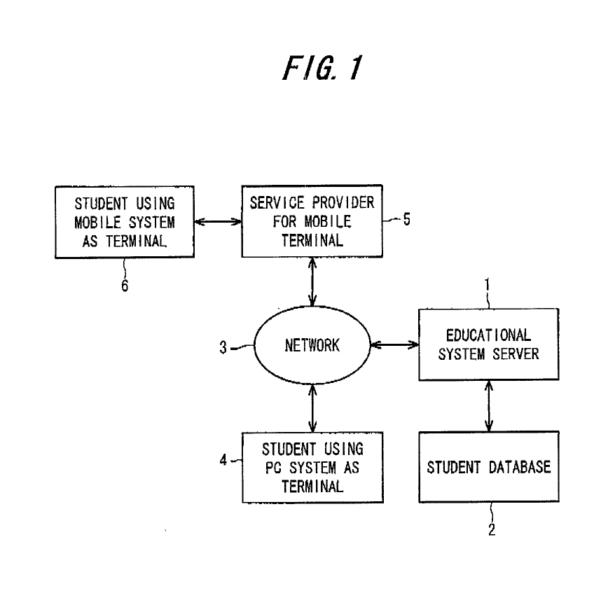

FIG. 1 is a block diagram showing the whole construction of the educational system according to the invention. In FIG. 1, an educational system server 1 is connected through a network 3, such as internet, to a service provider 5 for mobile terminals and a terminal on a student side using PC as the terminal. The service provider 5 for mobile terminals is also connected through radio communication to a terminal 6 on a student side using a mobile system as the terminal. The educational system server 1 is connected to a student database 2 which stores and manages various data sent from the terminal 4 on the student side using PC as the terminal and from the terminal 6 on the student side using the mobile system as the terminal. Based on this construction, each student takes various educational courses through the terminal 4 on the student side using PC as the terminal or the terminal 6 on the student side using the mobile system as the terminal.

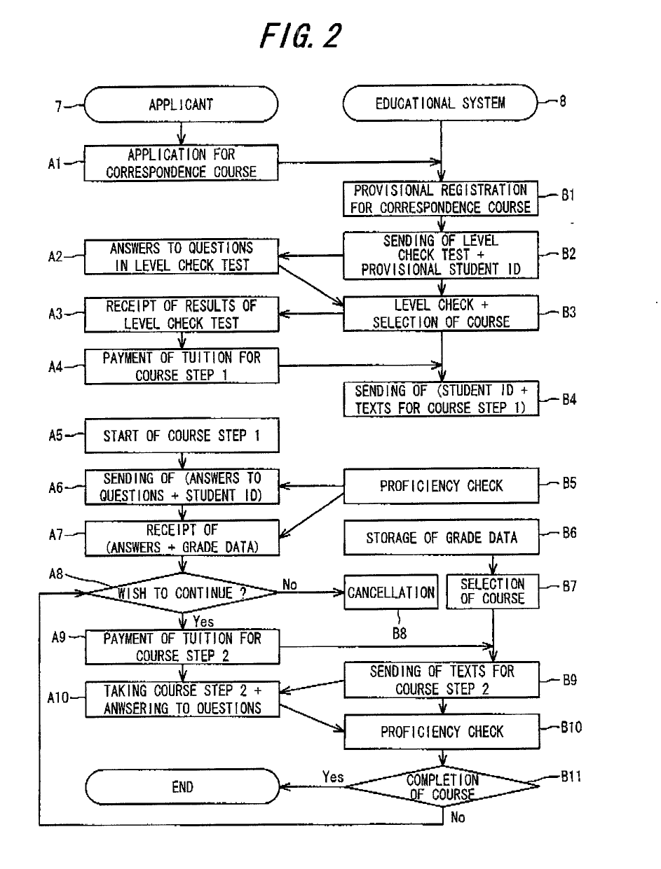

FIG. 2 is a flow chart showing the flow of processing between a student and an educational system. The operation of the invention will be explained in conjunction with FIG. 2.

An applicant 7 (who wishes to be a student for a correspondence course) accesses an education system 8 through the terminal 4 on the applicant side, which is PC, or the terminal 6 on the applicant side, which is a mobile system, to perform an application for taking correspondence course (step A1).

The educational system 8, which has received the application for taking correspondence course, issues provisional registration for correspondence course and a provisional student ID, and stores these data in the student database 2 (step B1) . Next, the educational system 8 transmits the provisional student ID and a level check test to the applicant 7 (step B2).

Upon the receipt of the level check test, the student 7 answers to questions in the level check test and transmits the answers to the educational system 8 (step A2).

Based on the score of the level check test received from the student 7, the educational system 8 determines the current ability level of the student and, in addition, selects a course which matches the current ability level of the student (step B3).

The student 7 receives the results of the level check test and the name of the course selected and proposed by the educational system 8 (step A3), and, based on this, decides whether or not he or she takes the proposed course. When the student has decided to take the proposed course, he or she pays online though the network tuition only for the selected course step 1 to the educational system 8 (step A4).

After the educational system 8 confirms that the tuition has been paid by the student, the educational system 8 transmits a student ID and texts for the selected course step 1 to the student 7 (step B4). In this connection, it should be noted that the texts are data transmittable through the network 3 and examples thereof include text data, HTML data, voice data, and image data.

The student 7, after the receipt of the student ID and the texts through the network, begins to learn based on the texts (step A5). The student 7 answers questions in a proficiency level check test and transmits the answers, together with the student ID, to the educational system 8 (step A6).

The educational system 8 grades (marks) the answer data transmitted from the student 7, and determines the current proficiency level of the student 7 (step B5) . Further, the educational system 8 stores the results of grading and grade data in the student database 2 and, in addition, transmits them to the student 7 (step B6).

The student 7 receives the results of grading and the grade data (step A7), and, based on these data, decides whether he or she continues the course and advances to a next course step or cancels the course (step A8). when the student 7 wishes to cancel the course, he or she transmits to that effect to the educational system 8 (step B8). On the other hand, when the student 7 wishes to continue to take the course, the student 7 pays tuition for a next course step online to the educational system (step A9).

After the educational system 8 confirms that the student has paid the tuition for the next course step, the educational system 8 selects a suitable next course step based on the student's grade stored in the student database 2 (step B7), and transmits, to the student 7, texts for a selected course step 2 (step B9).

The student 7 begins to learn according to the texts for the course step 2, and transmits answers to questions in the texts to the educational system 8 (step A10).

Upon the receipt of the answers to the questions in the texts for the course step 2, the educational system 8 grades the answers, again determines the current proficiency level of the student 7 based on the results of grading (step B10), and, based on the results of the current proficiency level check, judges whether the proficiency level of the student 7 corresponds to the completion of the course or is such that the student 7 should still continue the course (step B11). In the case of the completion of the course, the educational system 8 transmits to that effect together with the results of grading to the student 7, and this ends the course (step A11). On the other hand, when the educational system 8 has judged that the current proficiency level of the student 7 is unsatisfactory and the continuation of the course is necessary, the educational system 8 transmits to that effect together with the results of grading to the student 7 (step A8).

Based on this, the student 7 decides whether or not he or she continues the course. When the student 7 wishes not to continue the course, the student 7 cancels the course (step B8). On the other hand, when the student 7 wishes to continue the course, he or she pays tuition for the continuation of the course, and continues the course (step A9).

Thus, the practice of the level check test before the payment of the tuition enables the educational system to select a course suitable for the student. This can avoid that the student cannot decide which course is suitable for him or her. Further, since the tuition is paid for each step, there is no need for the student to previously pay all monies at a time for the course and, in addition, the student can cancel the course during taking the course. Further, regarding the completion of the course, the educational system determines the proficiency level of the student based on the results of the test, and, based on the results of the test, judges whether the proficiency level of the student corresponds to the completion of the course or is such that the student should still continue the course. Therefore, this enables the student to continue the course without ending the course when the current proficiency level of the student is unsatisfactory for the completion of the course.

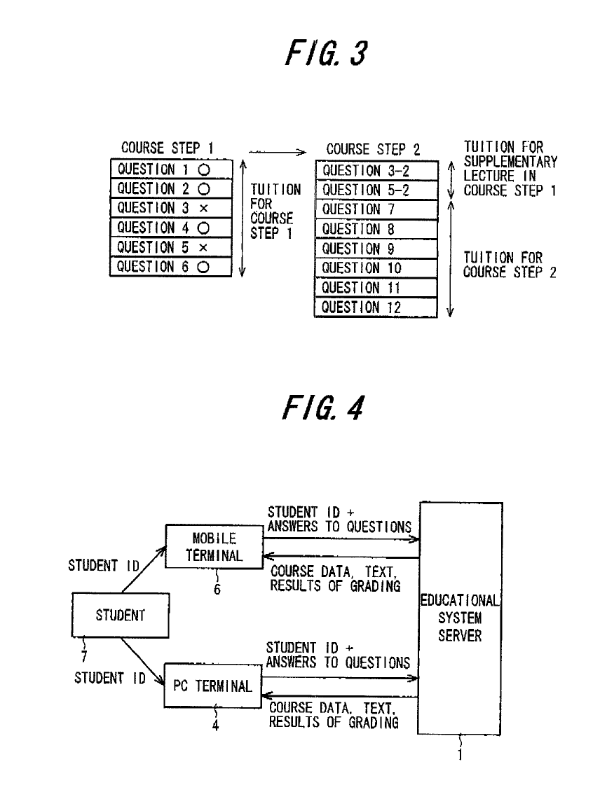

Next, the course step 1 and the course step 2 shown in FIG. 2 will be explained in more detail in conjunction with FIG. 3.

Regarding student's answers to questions 1 to 6 in the course step 1, when the results of grading are as indicated in terms of ◯X in the drawing, that is, when the questions 3 to 5 are incorrect, questions in the texts for the course step 2 include a question 3-2, which is a question similar to the question 3, a question 5-2, which is a question similar to the question 5, and questions 7 to 12 which are questions associated with the course step 2. In this case, fees for supplementary lectures associated with the questions 3-2 and 5-2 are added to the tuition for the course step 2.

Thus, based on the results of grading in each course step, the supplementary lecture in the preceding course step is added to questions in the next course step. Therefore, the student can surely improve the ability level step by step according to the current proficiency level. Further, the tuition can be paid according to the proficiency level of the student.

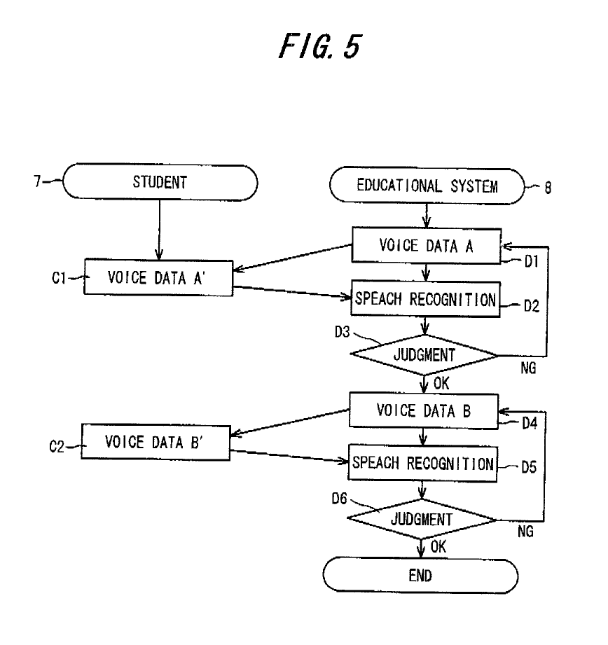

Next, the operation of an embodiment, wherein the student 7 uses both the PC terminal 4 and the mobile terminal 6 shown in FIG. 1, will be explained in conjunction with FIG. 4. When the student 7 accesses the educational system server 1 through the PC terminal 4 and the mobile terminal 6, he or she uses the student ID. In this case, the answers to the questions in each course step can be transmitted using the student ID to the educational system server 1 through the PC terminal 4 or the mobile terminal 6. Further, the course data, the texts, and the results of grading can be received using the student ID through each of the terminals.

Thus, the use of the student ID permits the student 7 to take the course everywhere independently of the terminal.

Next, the second preferred embodiment will be explained in conjunction with FIG. 5. When the student 7 performs pronunciation practice and speaking practice in language education, the educational system 8 transmits voice data A through the network 3 to the student 7 (step D1). The student 7 reproduces the voice data A in the PC terminal 4 or the mobile terminal 6. After the student 7 listens to the voice data A, the student 7 vocalizes the same sound. The voice pronounced by the student is converted through a microphone to voice data A′ which is then transmitted to the educational system 8 (step C1). The educational system 8 analyzes the pronunciation, words, and sentences in the voice data A′ through the speech recognition system (step D2), calculates the similarity between the voice data A and the voice data A′, and then judges whether or not the pronunciation of the student is correct (step D3). When the judgment is that the pronunciation of the student is NG, the student again vocalizes the sound. In this way, the student practices repeatedly until the pronunciation becomes correct. When the judgment is that the pronunciation of the student is OK, the educational system 8 transmits voice data B as a next question (step D4). The student 7 transmits voice data B′ to the educational system 8 (step C2). The educational system 8 performs speech recognition of the voice data B′ (step D5), and judges whether or not the pronunciation of the student is correct (step D6). When the judgment is that the pronunciation of the student is OK, this course step is ended (step D7).

When the above operation is performed through the network 3 on a real-time basis, the student 7 can immediately confirm the results of his or her pronunciation or sentence, and can also practice repeatedly. Further, when the connection charge of the network 3 is accounted based on the packet quantity of the voice data rather than the time used, the student 7 can practice repeatedly regardless of the time used.

Further, according to this preferred embodiment, the additional provision of a camera, an image scanner, and image recognition means can realize education of calligraphies, pictures and the like.

According to the invention, the following effects can be attained.

First, the system can immediately select and provide an educational course, which matches the ability level of the student, without the need for the student per se to select the educational course. This is so because the educational system can perform a level check test through a network prior to the selection of the educational course and, based on the results of the level check test, determine the ability level of the student, and select a course suitable for the student.

Second, the student can review or can practice repeatedly according to the student's proficiency level of the study, and can pay tuition or cancel the course for each course step during taking the course, because the student pays the tuition online through the network while the educational system transmits texts and questions according to the status of the payment of the tuition and the current proficiency level of the student.

Third, for example, in the education of languages, calligraphies, and pictures, the results of speaking practice, pronunciation, and the practice of calligraphy can be confirmed on a real-time basis through a network such as internet, because voice data and animation data as well as text data can be transmitted and received on a real-time basis.

The invention has been described in detail with particular reference to preferred embodiments, but it will be understood that variations and modifications can be effected within the scope of the invention as set forth in the appended claims.

What is claimed is:

1. A business system for a correspondence course, comprising an educational system server which educates a student through a communication network, wherein
said educational system server preliminary examines the ability level of the student, and, based on the results of the examination, selects a suitable course for the student.

2. The business system according to claim 1, wherein the educational system server, only when the student has paid tuition for the selected course, educates the student according to the course.

3. The business system according to claim 1 or 2, the course comprises a plurality of course steps and the educational system server executes only the course step for which the student has paid tuition.

4. The business system according to claim 1, 2, or 3, wherein the course comprises a plurality of course steps and the educational system server selects a next course step suitable for the student based on the current proficiency level of the student.

5. The business system according to claim 1, 2, 3, or 4, wherein the communication network performs language education through transmission of voice data.

6. The business system according to claim 1, 2, 3, or 4, wherein the communication network performs education of calligraphy, pictures and the like through transmission of image data.

7. A correspondence course system comprising a terminal on a student side connected through a communication network to an educational system server which transfers examination questions and the results of grading to the terminal on the student side, wherein
said educational system server preliminary examines the ability level of the student, and, based on the results of the examination, selects a suitable course for the student.

8. The correspondence course system according to claim 7, wherein the educational system server, only when the student has paid tuition for the selected course, educates the student according to the course.

9. The correspondence course system according to claim 7 or 8, the course comprises a plurality of course steps and the educational system server executes only the course step for which the student has paid tuition.

10. The correspondence course system according to claim 7, 8, or 9, wherein the course comprises a plurality of course steps and the educational system server selects a next course step suitable for the student based on the current proficiency level of the student.

11. The correspondence course system according to claim 7, 8, 9, or 10, wherein the educational system server comprises database means for storing student ID, proficiency level, status of payment of tuition and the like of students.

12. The correspondence course system according to claim 7, 8, 9, 10, or 11, wherein the terminal on the student side comprises means for converting the voice of the student to voice data and the educational system server comprises means for evaluating pronunciation of the student, words, and sentences.

13. The correspondence course system according to claim 7, 8, 9, 10, or 11, wherein the terminal on the student side comprises means for converting images written, painted, or drawn by the student, such as pictures or calligraphies, to image data and the educational system server comprises means for evaluating pictures, calligraphies and the like.

14. The correspondence course system according to claim 7, 8, 9, 10, 11, 12, or 13, wherein the terminal on the student side is a personal computer or a portable terminal.
